(19) United States
(12) Patent Application Publication
(10) Pub. No.: US 2024/0187155 A1
(43) Pub. Date: Jun. 6, 2024

(54) CONTROL METHOD OF ELECTRONIC DEVICE FOR UNIDIRECTIONAL DATA TRANSMISSION

(71) Applicant: MEDIATEK INC., Hsin-Chu (TW)

(72) Inventor: Meng-Jer Tsai, Hsinchu City (TW)

(73) Assignee: MEDIATEK INC., Hsin-Chu (TW)

(21) Appl. No.: 18/525,870

(22) Filed: Dec. 1, 2023

Related U.S. Application Data
(60) Provisional application No. 63/385,786, filed on Dec. 2, 2022.

(51) Int. Cl. H04L 5/00

(52) U.S. Cl. CPC H04L 5/0033; H04L 5/0048

(57) ABSTRACT

The present invention provides a control method of an electronic device, wherein the control method includes the steps of: establishing a link with a device; determining a transmission setting without negotiating with the device, wherein the transmission setting includes a cycle period of a cycle, a transmission period and a transmission-blocking period, and the cycle period includes the transmission period and the transmission-blocking period; and transmitting data to the device according to the transmission setting.

### CROSS REFERENCE TO RELATED APPLICATIONS

This application claims the benefit of U.S. Provisional Application No. 63/385,786, filed on Dec. 2, 2022. The content of the application is incorporated herein by reference.

### BACKGROUND

People face challenges while viewing the web pages, images, and other media content on mobile devices such as smartphones or tablets. These devices have a small display area to display the desired content, so the user often cannot see the content clearly. Hence, many users of the mobile devices use a wireless display broadcasting mechanism to use a large display screen such as a TV screen while accessing the pages, images, and media content on the mobile devices.

Miracast is a wireless communications standard created by the Wi-Fi Alliance which is designed to transmit video and sound directly from the mobile devices, such as tablets or smartphones, to display device such as TVs, monitors, or projectors. However, when using the Miracast specification, some negotiation and authentication operations are required between the mobile device and the display device, and a null frame containing a power management bit also needs to be transmitted from the mobile device to inform the display device whether the mobile device is in a normal mode or a sleep mode. These negotiation operations and the transmission of null frames will increase the power consumption of the mobile device, thus shortening the usage time of the mobile device.

### SUMMARY

It is therefore an objective of the present invention to provide a wireless communication method, which can reduce the number of transmissions of null frames, to solve the above-mentioned problems.

According to one embodiment of the present invention, a control method of an electronic device comprises the steps of: establishing a link with a device; determining a transmission setting without negotiating with the device, wherein the transmission setting comprises a cycle period of a cycle, a transmission period and a transmission-blocking period, and the cycle period comprises the transmission period and the transmission-blocking period; and transmitting data to the device according to the transmission setting.

According to one embodiment of the present invention, an electronic device comprising a processing circuit and a wireless communication module is disclosed. The wireless communication module is configured to perform the steps of: establishing a link with a device; determining a transmission setting without negotiating with the device, wherein the transmission setting comprises a cycle period of a cycle, a transmission period and a transmission-blocking period, and the cycle period comprises the transmission period and the transmission-blocking period; and transmitting data to the device according to the transmission setting.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system according to one embodiment of the present invention.

FIG. 2 is a control method of the source device according to one embodiment of the present invention.

FIG. 3 shows a data transmission between source device and sink device according to one embodiment of the present invention.

FIG. 4 shows a data transmission between source device and sink device according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

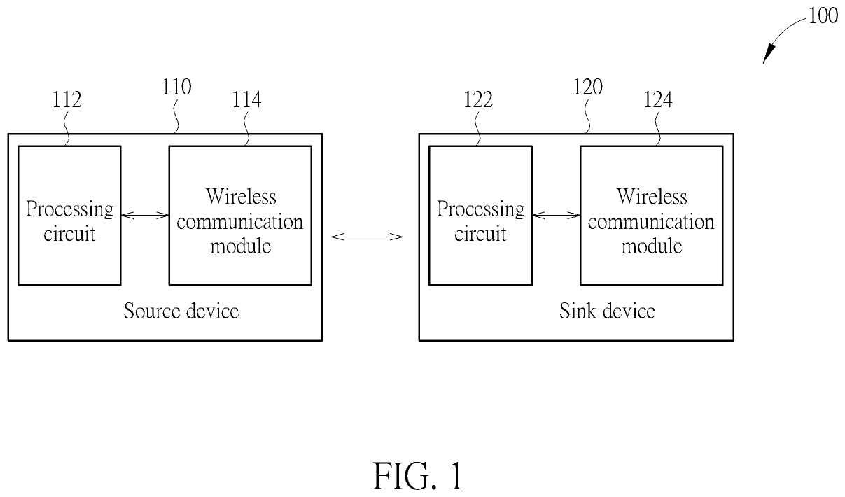

FIG. 1 is a diagram illustrating a wireless communication system 100 according to one embodiment of the present invention. As shown in FIG. 1, the wireless communication system 100 comprises a device 110 which is taken as a source device and another device 120 which is taken as a sink device, wherein the source device 110 comprises at least a processing circuit 112 and a wireless communication module 114, the sink device 120 comprises at least a processing circuit 122 and a wireless communication module 124, the processing circuit 112/122 may be a processor or an application processor, and the wireless communication module 114/124 comprises a medium access control (MAC) layer circuitry and a physical layer circuitry.

In this embodiment, the source device 110 and the sink device 120 support Wi-Fi Display (WFD) function such as Wi-Fi certified Miracast standard, that is the users can wirelessly share multimedia between the source device 110 and the sink device 120, even if a Wi-Fi network is not available. In one embodiment, the source device 110 can be any device such as a smartphone or a tablet, and the sink device 120 can be any device having a display panel, such as a TV or an automobile infotainment system. The source device 110 is configured to transmit data to the sink device 120 wirelessly, and the sink device 120 displays the data (such as image date) received from the source device 110.

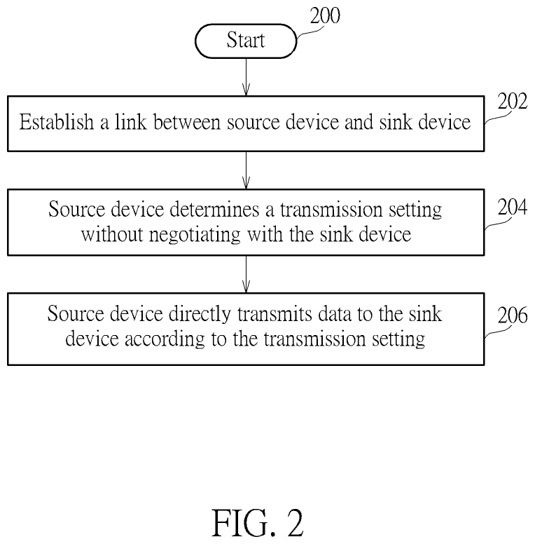

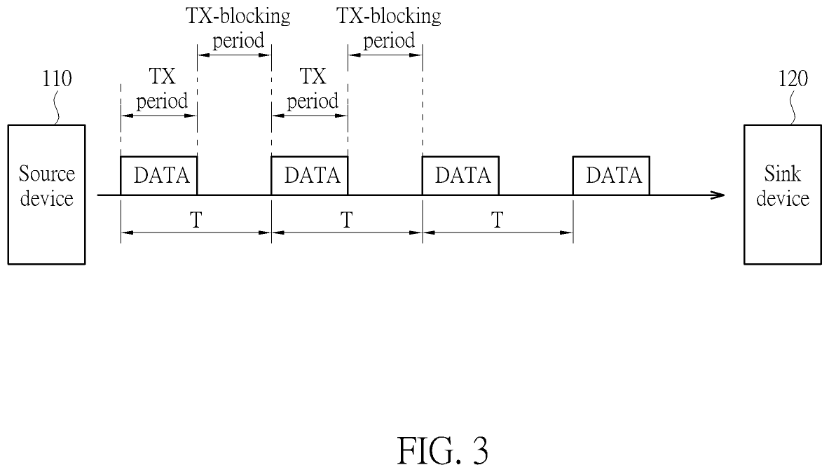

FIG. 2 is a control method of the source device 110 according to one embodiment of the present invention. In Step 200, the flow starts. In Step 202, the source device 100 establishes a link with the sink device. Taking Miracast standard as an example, the source device 110 and the sink device 120 may perform association/authentication/4-way hand shaking, WFD capability negotiation, WFD session establishment, etc., in sequence with the sink device 120. In Step 204, the wireless communication module 114 determines a transmission setting comprising a cycle period, a transmission period (hereinafter, TX period) and a transmission-blocking period (hereinafter, TX-blocking period). Taking FIG. 3 as an example, the cycle period “T” comprises one TX period and one TX-blocking period, and the source device 110 is allowed to transmit data to the sink device 120 during the TX period, and the source device 110 does not transmit any data to the sink device 120 during the TX-blocking period.

In addition, the source device 110 can determine transmission setting comprising the cycle period, the TX period and the TX-blocking period based on the internal information or the information of the sink device 120 obtained while establishing the link in Step 202, but the source device 110 does not negotiates the transmission setting with the sink device 120. For example, the source device 110 can determine transmission setting according to preset parameters of the source device 110, and/or data transmission rate that will be used to transmit data form the source device 110 to the sink device 120, or the receiving ability of the sink device 120 obtained in Step 202.

In Step 206, the source device 110 directly transmits data to the sink device 120 (unidirectional data transmission), without negotiating with the sink device 120 and without notifying the transmission setting to the sink device 120 first. That is, the sink device 120 does not know the time length of the cycle period or the time length of the TX period. In this embodiment, because the source device 110 and the sink device 120 do not negotiate the transmission setting, the burden of the source device 110 and the sink device 120 will be reduced.

In one embodiment, referring to FIG. 3, the source device 110 does not send any null frame containing power management information to the sink device 120 during the cycles, and the wireless communication module 124 of the sink device 120 is always enabled so that the video data and/or audio data from the source device 110 can be successfully received. In this embodiment, the power management information is a power management bit indicating whether the source device 110 is in an active mode or a sleep mode. In the conventional art, the source device will send the null frame containing the power management bit “0” to the sink device to indicate that the source device is in the active mode, then the source device can send data to the sink device; and when the source device is about to enter the sleep mode, the source device will send the null frame containing the power management bit “1” to the sink device. Because the conventional art needs to send the null frame containing the power management bit before and after the data transmission, it will increase the burden and power consumption of the source device. In this embodiment, because the source device 110 does not transmit the null frame containing the power management information at the beginning of the TX period, the power consumption of the source device 110 can be greatly reduced.

In one embodiment, in the TX period, the wireless communication module 114 of the source device 110 operates in the active mode so that the video and/or audio data is transmitted to the sink device 120; and in the TX-blocking period, the wireless communication module 114 operates in the sleep mode, that is at least a portion of the circuitry such as analog front-end circuits is disabled to decrease the power consumption.

In one embodiment, in the TX period, the wireless communication module 114 of the source device 110 operates in the active mode so that the video and/or audio data is transmitted to the sink device 120; and in the TX-blocking period, the wireless communication module 114 operates in a light-weight radio mode, that is only part of the circuitry of the wireless communication module 114 is enabled for receiving packets with lower data rate (i.e., lower modulation and coding scheme (MCS) index), to lower the power consumption of the wireless communication module 114.

In one embodiment, in the TX period, the wireless communication module 114 of the source device 110 operates in the active mode so that the video and/or audio data is transmitted to the sink device 120; and in the TX-blocking period, the wireless communication module 114 initially operates in the sleep mode, a detection circuit is enabled to detect if receiving data packets from the sink device 120, and a light-weight receiver within the wireless communication module 114 is activated when receiving the data packets.

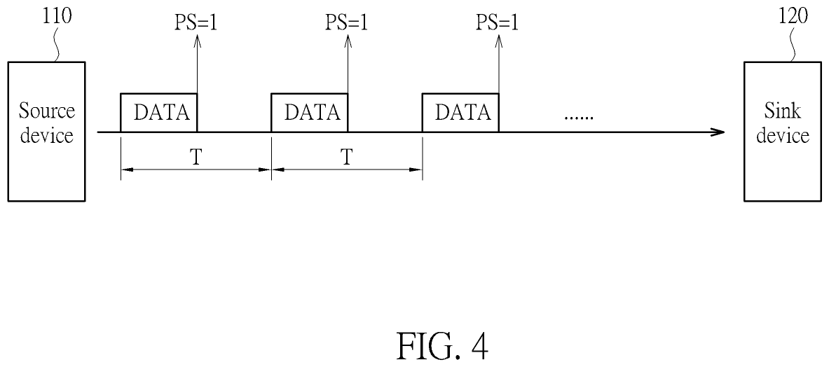

In another embodiment, referring to FIG. 4, the source device 110 only sends part of null frames containing power management information to the sink device 120 during the cycles, and the wireless communication module 124 of the sink device 120 can enter or leave the sleep mode according to the null frames and the received data. In this embodiment, the power management information is a power management bit indicating whether the source device 110 is in an active mode or a sleep mode. In this embodiment, at the beginning of the TX period within a cycle, the source device 110 does not send the null frame containing the power management bit “0” to the sink device 120, that is, the source device 110 directly send the data to the sink device 120 during the TX period, and the sink device 120 is triggered by the data to enter the active mode from the sleep mode. Then, at the end of the TX period, the source device 110 sends the null frame containing the power management bit “1” to the sink device 120, to inform the sink device 120 that the source device 110 enters the sleep mode. After receiving the null frame containing the power management bit “1”, the wireless communication module 124 of the sink device 120 may enter the sleep mode to lower the power consumption.

Briefly summarized, in the control method of the source device of the present invention, by determining the transmission setting having TX period and TX-blocking period without negotiating with the sink device, and/or performing unidirectional data transmission without sending the null frames having power management information, the power consumption of the source device can be greatly reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of an electronic device, comprising:
establishing a link with a device;
determining a transmission setting without negotiating with the device, wherein the transmission setting comprises a cycle period of a cycle, a transmission period and a transmission-blocking period, and the cycle period comprises the transmission period and the transmission-blocking period; and
transmitting data to the device according to the transmission setting.

2. The control method of claim 1, wherein the step of transmitting the data to the device according to the transmission setting comprises:
transmitting the data to the device during the transmission period of the cycle; and
not transmitting any frame comprising power management information indicating whether the electronic device is in an active mode or a sleep mode at a beginning of the transmission period.

3. The control method of claim 2, wherein the step of transmitting the data to the device according to the transmission setting further comprises:
not transmitting any frame comprising the power management information indicating whether the electronic device is in the active mode or the sleep mode at an end of the transmission period.

4. The control method of claim 2, wherein the step of transmitting the data to the device according to the transmission setting further comprises:
transmitting a frame comprising the power management information indicating that the electronic device is in the sleep mode at an end of the transmission period.

5. The control method of claim 2, wherein the step of transmitting the data to the device during the transmission period of the cycle is a unidirectional data transmission.

6. The control method of claim 1, further comprising:
operating in a sleep mode during the transmission-blocking period.

7. The control method of claim 1, further comprising:
operating in a light-weight radio mode to enable only part of a wireless communication module of the electronic device.

8. The control method of claim 1, wherein the electronic device and the device support Wi-Fi Display (WFD) function.

9. An electronic device, comprising:
a processing circuit; and
a wireless communication module;
wherein the wireless communication module is configured to perform the steps of:
establishing a link with a device;
determining a transmission setting without negotiating with the device, wherein the transmission setting comprises a cycle period of a cycle, a transmission period and a transmission-blocking period, and the cycle period comprises the transmission period and the transmission-blocking period; and
transmitting data to the device according to the transmission setting.

10. The electronic device of claim 9, wherein the step of transmitting the data to the device according to the transmission setting comprises:
transmitting the data to the device during the transmission period of the cycle; and
not transmitting any frame comprising power management information indicating whether the electronic device is in an active mode or a sleep mode at a beginning of the transmission period.

11. The electronic device of claim 10, wherein the step of transmitting the data to the device according to the transmission setting further comprises:
not transmitting any frame comprising the power management information indicating whether the electronic device is in the active mode or the sleep mode at an end of the transmission period.

12. The electronic device of claim 10, wherein the step of transmitting the data to the device according to the transmission setting further comprises:
transmitting a frame comprising the power management information indicating that the electronic device is in the sleep mode at an end of the transmission period.

13. The electronic device of claim 10, wherein the step of transmitting the data to the device during the transmission period of the cycle is a unidirectional data transmission.

14. The electronic device of claim 9, further comprising:
operating in a sleep mode during the transmission-blocking period.

15. The electronic device of claim 9, further comprising:
operating in a light-weight radio mode to enable only part of a wireless communication module of the electronic device.

16. The electronic device of claim 9, wherein the electronic device and the device support Wi-Fi Display (WFD) function.
